(19) United States
(12) Patent Application Publication
(10) Pub. No.: US 2003/0028399 A1
(43) Pub. Date: Feb. 6, 2003

(54) Method and system for providing interactive health care services

(76) Inventors: Duane Davis, Atlanta, GA (US); Gregory Barrett, Hayesville, NC (US)

Correspondence Address: STEPHEN M. SCHAETZEL, KILPATRICK STOCKTON LLP, Suite 2800, 1100 Peachtree Street, Atlanta, GA, 30309-4530, US

(21) Appl. No.: 09/963,099

(22) Filed: Sep. 24, 2001

Related U.S. Application Data
(60) Provisional application No. 60/235,977, filed on Sep. 28, 2000.

(51) Int. Cl. G06F 17/60

(52) U.S. Cl. 705/2

(57) ABSTRACT

The present invention comprises and discloses an integrated care management modules that, using a global computer network (the “Internet”) and/or other communication devices, provides for the scheduling, dispatching and tracking of communications between a clinician (doctor, internist, etc.) and a patient.

### TECHNICAL FIELD

The present invention relates generally to the provision of interactive health care services. More particularly, the present invention relates to the provision of interactive health care services that include services such as patient coaching and consultation that guide and direct the patient to take appropriate health action. The present invention includes integrated care management modules to provide online care management and wellness initiatives for all diseases, acuity levels and health states. Further, the present invention provides for interactive clinical collaboration between the physician or clinician and the patient in a manner that enables the physician, clinician or groups thereof to direct and supervise patients' healthy behavior between traditional episodes of care.

### BACKGROUND

Much has been made of the need to improve the delivery of health care services. Presidential commissions have been established to investigate or design improved and more economical health care systems. Many of such efforts have failed for a variety of reasons. Such efforts have often received both praise and criticism, in large part due to the size of the system and the vast number of problems to be addressed.

Many challenges are presented. One challenge focuses on the interface between patient and doctor, nurse, case manager, health aide, pharmacist and the like (clinician). From the doctor's or clinician's point of view, there is only a fixed amount of time within which to interact with the patient, to make a diagnosis and to inform the patient thereof. There is often little to no time for follow-up education or treatment. From the patient's point of view, the patient understandably may feel hurried or even rushed as the doctor or clinician only has limited time that must be managed effectively.

In terms of time management, the doctor's or clinician's schedule and the patient's needs seldom match. Oftentimes, the patient is in need of the doctor or clinician at a time when the doctor or other clinician is unavailable. Such unavailability may be the result of the time spent with other patients or otherwise. Of course, a well-known response to this problem is the use of a “on-call” telephonic system, where the doctor or clinician is in a business relationship with another doctor or clinician that can and does substitute for the patient's primary doctor or clinician. While this system has proven useful, it suffers from the inability to allow either the clinician or the patient to influence or to be a contributing part of treatment implementation. There is almost always a third party (such as a call answering service person or even a call answering machine) between the patient and the doctor.

Moreover, the interaction between the clinician and the patient is essentially crisis driven. While some may schedule a preventative maintenance physical or the like, many interactions between a doctor or clinician and a patient are driven by a patient's need for health care. There is little if any opportunity for the doctor or clinician to direct and advise the patient on new developments in medicine, new treatment or medications, or other beneficial information outside of a visit to the hospital or the doctor's office. There is, therefore, a need for a personalized health care service that allows more ready access to both the patient and the clinician, that facilitates communication therebetween, and that encourages and enables preventive self-care by dissemination of information and tools collateral with or even outside of a crisis situation or core episode.

Further, health care professionals and others will appreciate that there are a number of acute, chronic or other illnesses that require ongoing care such as monitoring or could, at a minimum, benefit from a monitoring program. In these cases, such as concerning a diabetic patient or concerning a cancer patient, the doctor or clinician and the patient are in many respects “managing” the disease. Disease management techniques are rarely taught and, as a result, patients may fail to perform health-related tasks effectively. Such health-related tasks include various activities, ranging from tracking symptoms, and tracking vital signs such as blood pressure, heart rate, weight and the like, and tracking laboratory results such as glucose, cholesterol, and the like, to taking medications. Common prior art responses to the need for management of diseases include paper-based schedules and input forms a nurse calling to collect information and to encourage action, and pill dispensers that may be organized by day or some other time period. Of course, such a care management system requires that the patient (or someone aiding on their behalf) organize the medications in accordance with the dispenser or other device and manage the collection and dissemination of the data regarding monitored vital signs. These typical efforts at disease (or care) management have tended to result in uncoordinated and disjointed efforts amongst those interacting with the patient.

Yet further, there is much that a patient can do to assist in the treatment of diseases or a chronic disease situation. For example, a patient may affect a particular outcome if the patient knows why, what, and when certain health events need to occur or be performed, and as such, had access to a customized or individualized health plan that included training and personalized health-related instructions and information. In an improved system, the patient's implementation of such a plan could be monitored and adjusted as necessary by a doctor or clinician. For example, the patient could track symptoms, or even how he or she feels at a given point, or over a defined period of time. The patient could collect such historical information and then provide that history to the doctor or clinician to assist in the diagnosis or to modify a treatment plan.

While it is generally recognized that the healthcare industry must encourage better patient self-care, there are presently no economical methods today to enable the patient, family members, caregivers or clinician to know if the patient and caregivers have mastered the knowledge needed to employ good self-care, particularly to the point of having developed healthy habits. Further, there is no economical way to enable and support clinical collaboration among various members of the entire health care team.

Thus, there is a need and an opportunity in the art for an improved health care system and method that addresses needs of both the clinician and the patient. Such a system and method would preferably be interactive. An improved system and method could assist patients by providing information and on-line educational courses regarding the “when, what, where, why and how” concerning the patient's condition or conditions, and about their medications. An improved health care system could measure patient mastery of such information, identify gaps in a patient's knowledge or execution of self-care procedures, provide opportunities to fill in any such gaps by means of on-line communications and navigation tools, and provide a structured method to facilitate and practice healthy lifestyle changes. An improved system could allow the patient to initiate appropriate interaction and, therefore, care at the appropriate time. An improved system and method could allow the doctor or clinician (or their agents) to collaborate with and provide information to the patient outside of the traditional crisis-based, office driven contact. Such a system and method could allow the doctor or clinician (or their agents) to effectively prescribe and provide educational materials or courses that may benefit the patient's condition, to identify gaps in patient understanding that would increase the risk of adverse events or lower chances of improved outcomes, and would likewise allow the patient to immediately ask questions of the doctor or clinician in confidence and in a convenient manner. The patient would preferably be able to ask questions regarding not only a disease or treatment, but also about that particular patient's gaps in knowledge or execution. The clinician could preferably support and monitor a patient's learning, and health progress in real time rather than in discrete, oftentimes episodic random office visits. Such a system and method would further allow for disease management and preventative care by providing a schedule for educational courses, and a prescribed health routine including medications, self-monitoring events, lab tests with reminders, and for symptom history collection, verification and treatment modification.

It is a reality of health care that much of the cost is borne by a patient's employer by means of insurance programs, health management organizations (“HMO”) and other cooperative efforts. Thus, the preferred system would assist the employer in reducing sick leave or sick days, and lowers the cost of medical treatment. Given that patients are typically reluctant to disclose health conditions to anyone other than their respective doctor or clinician, and given that the doctor/patient relationship is grounded on trust and confidentiality, the preferred system would provide private, confidential and secure electronic communications methods but nonetheless maintain a complete network between the patient's doctor or clinician, other care team members and the patient and family members. Further, the improved system would collect and aggregate (not necessarily patient specific data) for the purpose of identifying gaps of knowledge and execution across subsets of populations so that health care delivery organizations, health insurance payers, employers and other sponsors of the health care system may intelligently identify areas in which to focus sponsored health and wellness initiatives.

### SUMMARY OF THE INVENTION

The present invention fulfills the above-described needs in the prior art by providing a system and method for providing improved interactive health care. The present invention includes interactive patient coaching, monitoring and coaching, each of which contribute to the improved system of the present invention.

The present invention comprises integrated modules that allow health care providers, caregivers and patients to improve health while simultaneously reducing medical losses, sick days and overall health care costs. One module of the invention provides a system and method that encourages self-care and facilitates both patient involvement, patient education and patient mastery of health skills and related tasks. At the same time, a second module of the inventions provides electronic monitoring and automatic notification of a clinician or doctor of escalating conditions and gaps in patient knowledge or skills. A third module of the invention enables the health care community to support disease management and other programs that influence patient behavior through customized patient instructions, training and health regimes whereby a clinician or doctor can manage patient progress. A fourth module of the invention enables secure, HIPPA compliant communications, and clinical collaboration among and between members of the community of care surrounding the patient.

In a first preferred embodiment, the present invention includes a personal web page that serves as an Internet-based health coach that encourages patients to initiate self-education and self-care. This first preferred embodiment preferably provides patient instruction, training, testing and self-care tools with monitoring by, escalation to, and consultation with clinicians or doctors. Described somewhat more particularly, this first preferred embodiment includes a personal patient web page. This web page may use a patient's medication profile (or other medical profile as appropriate) that may be obtained from the patient, the patient's doctor or clinician, a pharmacy, an insurance company, or some other reliable source (or coordination of sources) that collect such information. This web page may display hyper-text links to services and information of particular interest to a particular patient or that has specific relevance to this patient's medical condition. This personalized web page, which may be prepared by a health care professional, is driven by a “health menu.” That menu may list a variety of different functions which may include:

(1) Health news;

(2) Health history and interests;

(3) Custom health surveys;

(4) Electronic messenger (including a conversational journal);

(5) Video consultation with doctor or clinician;

(6) Medication News;

(7) Learn health skills;

(8) Health Regimen and Reminders;

(9) Health Monitor; and

(11) Health Links.

Many other items could be provided. The present invention has application to a variety of services and should not be restricted to the preferred embodiment of health care services as described and claimed herein.

The present invention preferably includes a web page that facilitates a private communication link between the patient and a doctor or clinician. Moreover, it is preferred that the web page is entered by way of a login page and processes that insure that privacy. For example, this login may include a “name” indication and a password, or a biometric form of authentication. The use of a password, or a biometric form of authentication in conjunction with the name, adds yet another layer of security.

The Health Menu provides hyper-text links to the identified associated facilities. “Health News,” may provide information relating to newsworthy topics of general interest. “My History/Interests,” as a further example, may provide information specific to the patient. The Health Menu may thus be customized as desired.

In a second preferred embodiment, the present invention includes a rule-based module that interacts with the monitoring system and is capable of automatically notifying a doctor or clinician of an escalating or changing condition or a gap in patient knowledge or skill development. The doctor or clinician may be informed in any suitable manner, including by graphing, raw data, or other method. In the preferred embodiment, this module may include links such as: (1) In-Box; and (2) Journal. An “In-Box” link may provide for messages and the like from a doctor, clinician or authorized agent. The “Journal” preferably provides the patient and those interacting with the patient the ability to view all interactions presorted by conversational topics (or other parsing devices) to make future reference to past conversations simple and direct. The Journal” may preferably include and provide an electronic audit trail of the interaction between the patient and a doctor or clinician. A “Public Messages” link may be provided for secure communications not only for this particular patient, but for all patients that have a similar condition. For example, a patient and a doctor or clinician may want to make certain conversations that could aid others available to other patients to view and read.

Yet other fields or events may be specified. For example, the invention may include a measurement of emotional trauma, such as “How much have you been bothered by emotional problems today,” How anxious, depressed, irritable or downhearted has the patient felt, on balance. Such information may be provided by the patient on a graduated scale, ranging from “not at all” to “extremely.” Once again, a time and date indication may also be taken. Similar information may be recorded by the patient for heart rate, blood pressure, blood sugar or any other reasonably readily obtained health information. By providing this historical data to a doctor or clinician, the patient assists in the monitoring and diagnosis processes. Yet further, the preferred embodiment of the present invention may include a graphical representation of the historical data obtained and recorded as described hereinabove.

The present invention thus fulfills the above-described needs in the prior art by providing a system and method for scheduling, dispatching and tracking various types of communications between clinicians and patients. The present invention provides meaningful access to service providers for patients by means of a health planning, monitoring and reminder system that is capable of using the “World Wide Web” or Internet-based communication in conjunction with personal communication devices (such as pagers, mobile phones, wireless personal digital assistants, electronic letters and faxes), a consumer-based interface and supporting technology. The preferred system and method improve patient health by increasing adherence to medical regimens and disease management protocols. The preferred system and method are flexible in the application, and can be personalized for an individual patient or clinician. The preferred system and method provide means for mass customization and distribution of health services, thereby allowing the clinician to provide health service and information to the patient outside of the conventional, crisis-based appointment model with or without collaboration with other doctors, clinicians and caregivers.

The present invention encourages patients to be more involved and be more informed, and facilitates both. As a result, the present invention provides for the patient to make better decisions regarding his or her own health care. All such decisions, however, may be made under the control direction, supervision or auspices of the patient's personal, and health care professional.

The personal web page can then be reached by manipulating the Internet in the normal fashion to an appropriate web address. As described above, this personal web page provides the patient with a customized, personalized web page that gives them access to a variety of health care services, including:

(1) Personalized Web-based Patient Education Certification may include links to courses regarding medications and disease state regimen;

(2) Personal Health Newsletters—may include individualized news for ongoing patient education and awareness about patient's own personal medication and conditions;

(3) Personalized News about Medications and Conditions;

(4) Care Management Health Regimen;

(5) Schedule and Calendar of health-related events—may include a window of predetermined time period, such as 30 days;

(6) Electronic Interaction with Health Care Professional—such as doctor or pharmacist and may create a journal of questions and answers for future reference;

(7) Care Monitoring and Escalation Alerts—for example, where patient blood pressure, as monitored, exceeds recommended levels, the alert may be given to the health care professional and the patient;

(8) Video consultation—via off-the-shelf equipment well known for use with Internet, the patient may deal directly with the doctor or clinician without need of travel to the office or other location; and

(9) Electronic Triage of Acute Self-Limited Illness—links to a domain expert system providing electronic triage of acute self limited illnesses to front end consultations. Enables patient to answer questions about common problems and receive an indication of whether or not a doctor should be called.

In a third preferred embodiment, the present invention includes a comprehensive disease management and preventive health module. This module may include a web-based health planner and monitor that links important health events with wireless personal communication devices and personal computers. In this manner, the present invention serves to encourage and effect behavioral modification concerning health issues such as preventive health measure, medication regimens, diet control, smoking cessation, and cognitive training. Further, the invention enables pharmacists, doctors, clinicians and other caregivers to create care management plans for long term monitoring of diseases such as diabetes, asthma, congestive heart failure, other chronic diseases and the like. It is again to be appreciated that the present invention has applications well beyond the medical conditions described herein.

This portion of the invention may include the following elements displayed on a web page dynamically customized for each clinician (referred to in a proposed commercial embodiment as the “Professional MedPage) so as to enable that clinician to control and direct the patient's web page (referenced to in a proposed commercial embodiment as the “Personal MedPage”):

(1) Template Based Individualized therapy and care Planner—may provide a schedule for daily medications, self-monitoring of events such as measure peak flow rate (asthma), blood sugar (diabetes), blood pressure and weight;

(2) Schedule—plan may generate an identification of health related activities that can be viewed or printed at any location and allows for patient to enter indicators such as peak flow or blood sugar, etc.;

(3) Reminder messaging—may send reminder to pager, wireless PDA, phone, computer or fax indicating activity that is to be performed by patient;

(4) Automated Monitoring of Vital Information—any event can have a rule determined for it and an escalation procedure defined for it. If the rule is violated or exceeded, the invention automatically sends notice to the clinician or other health care professional;

(5) Clinician Intervention Support—may allow each clinician access to a patient's information on-line via reports and instant review of individual item. Clinician can then perform professional monitoring, can determine where patient is failing to perform appropriate monitoring or other task, institute alert or other change, and make notes to discuss with patient at appropriate time; and

(6) Clinician interface to private, confidential and secure messaging system for secure electronic mail and video clinical collaboration and communication with other clinicians, and electronic and video consultation with patients and family members.

The present invention is in part facilitated by a scheduling, escalation and communications infrastructure based upon the patient profile, the clinician profile and the care management planner. This infrastructure provides communication linkage between individuals authorized to communicate to and with the patient on behalf of the patient's physician, and control the content created on the patient's individualized web page. This infrastructure may comprise three major components, including an event monitor, an intelligent router and an event manager. The preferred event monitor continuously monitors therapy plans and looks for trigger event messages such as a reminder message or a scheduled event. The preferred intelligent router controls all scheduled and unscheduled communication notification between the patient and the doctor or clinician, and from the complete system to all users. For example, the router may send newsletters and alerts. The preferred event manager controls the process of dispatching messages to the servers sending messages to phones, pagers wireless PDA's etc. The internal or “back room” programs that drive such devices are discussed hereinbelow. The preferred embodiment of the present invention also includes a user interface that facilitates interaction between the user and the health care professional.

### BRIEF DESCRIPTION OF THE DRAWINGS

FIG. 1 is a schematic overview of the present invention.

FIG. 2 is an example screen display of a personal web page in accordance with the present invention.

FIG. 3 is an example screen display of a Health News web page in accordance with the present invention.

FIG. 4 is an example screen display of a Health News web page in accordance with the present invention.

FIG. 5 is an example screen display of a Health News web page in accordance with the present invention.

FIG. 6 is an example screen display of an “ask a pharmacist” feature in accordance with the present invention.

FIG. 7 is an example screen display of an “ask a pharmacist” feature in accordance with the present invention.

FIG. 8 is an example screen display of a “see a pharmacist” feature in accordance with the present invention.

FIG. 9 is an example screen display of a “medication news” aspect of the present invention.

FIG. 10 is an example screen display of a “learn health skills” aspect of the present invention.

FIG. 11 is an example screen display of a “health plan/reminder” aspect of the present invention.

FIG. 12 is an example scheduling format in accordance with the present invention.

FIG. 13 is an example screen display of a recorded monitored information format in accordance with the present invention.

FIG. 14 is an example screen display of a health plan/reminders aspect of the present invention.

FIG. 15 is an example screen display of a “my health monitor” aspect of the present invention.

FIG. 16 is an example screen display of an “archives” aspect of the present invention.

FIG. 17 is an example “log on” screen display for the provider's module of the present invention.

FIG. 18 is an example screen display for the “current customer list” aspect of the preferred invention.

FIG. 19 is an example screen display for the “current customer list” aspect of the preferred invention.

FIG. 20 is an example screen display for the “current customer list” aspect of the preferred invention.

FIG. 21 is an example screen display of the “preferences” aspect of the administration aspect of the current customer list in accordance with the present invention.

FIG. 22 is an example screen display of the “template maintenance” aspect of the current customer list in accordance with the present invention.

FIG. 23 is an example screen display of a template maintenance aspect of the current customer list in accordance with the present invention.

FIG. 24 is an example screen display of a customer maintenance aspect of the present invention.

FIG. 25 is an example screen display of a customer maintenance aspect of the present invention.

FIG. 26 is an example screen display of a customer maintenance aspect of the present invention.

FIG. 27 is an example screen display of a customer maintenance aspect of the present invention.

FIG. 28 is an example screen display of a customer maintenance aspect of the present invention.

FIG. 29 is an example screen display of a customer maintenance aspect of the present invention.

FIG. 30 is an example screen display of an event scheduling aspect of the present invention.

FIG. 31 is an example screen display of an event scheduling aspect of the present invention.

FIG. 32 is an example screen display of a personal profile or personal health plan for a patient in accordance with the present invention.

FIG. 33 is an example screen display of a disease management or care management aspect of the present invention.

FIG. 34 is a schematic diagram showing the electronic messaging aspect of the present invention.

FIG. 35 is a schematic diagram showing the electronic messaging aspect of the present invention.

### DETAILED DESCRIPTION

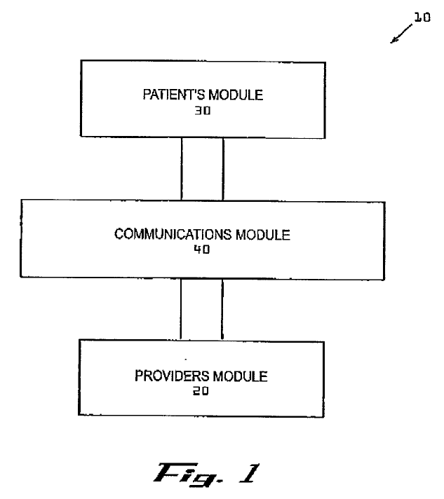

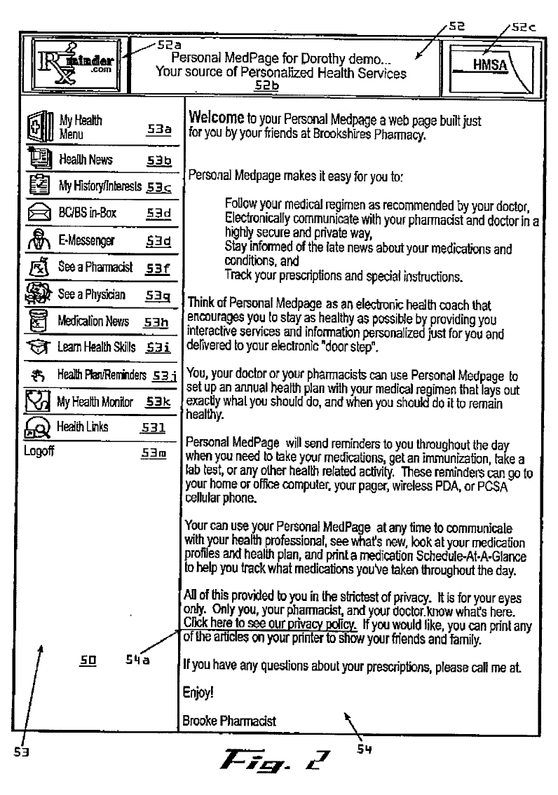

Referring in more detail to the drawings, in which like numerals reference like parts throughout the several views, it is to be understood that the present invention 10 includes two integrated care modules 20 and 30. The first module 20 is the doctor's or clinician's module, hereinafter referred to as “the Provider's Module.” The second module is the patient's module, hereinafter referred to as “the Patient's Module.” These first two modules are integrated with a communications module that links the Provider's Module and the Patent's Module 40 to provide an integrated unit. This third module 40 is hereinafter referred to as the Communications Module. The Communications Module 40 provides for scheduling, dispatching and tracking of communications between the patient and the health care provider. Each of these modules 20, 30 and 40 cooperate, as described below, to provide a system and method for the provision of health care services utilizing the Internet to enable a community of clinicians and caregivers to collaborate and serve the needs of patients. A diagram showing the inter-relation of these modules 20, 30 and 40, as a part of the invention 10, is shown in FIG. 1.

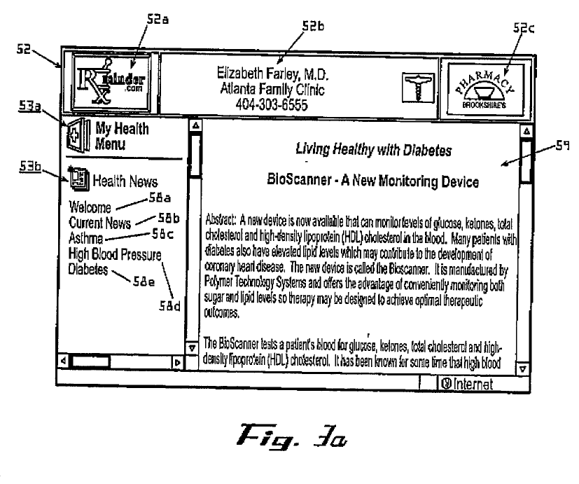

FIG. 2 shows an embodiment of an internet web page 50 that is a part of the Patient's Module in accordance with the present invention. Referenced by the trademark “Personal Medpage™, this portion of the Patient's Module 30 consists of a data driven web page 50 constructed for and customized to a specific patient. In this embodiment, the web page preferably provides three sections, including a banner 52, a menu 53 and an explanatory field 54. Those of ordinary skill will appreciate that the dimensions and composition of these sections may be varied and altered as desired.

The banner section 52 of web page 50 presents information according to a specific utilization. For example, the banner section 52 may provide information regarding sponsors, the patient's physician, clinician, therapist, etc. In a preferred form, the banner section 52 is comprised of three discrete areas, 52a, 52b and 52c. First area 52a may be utilized for branding the subject service, such as with the trademark “RxMINDER,” explained in greater detail below. Second area 52b may preferably be customized to include the patient's name, the physician's or health care professional's name. As shown, the information in Area 52b may, for example, state: “Personal MedPage™ for Dorothy Demo . . . Your Source of Personalized Health Services.” Of course, other language could be utilized. Third, area 52c may be utilized for sponsor branding. For example, a pharmacy may wish to advertise in this area. Such banner advertisements are well known in the art and need not be further described herein. It is also well known to utilize such banners in conjunction with a hypertext link. Thus, as a yet further example, the pharmacy advertisement in third area 52c may include or comprise a link to the pharmacy's website. Again, such technology and procedures are well known in the art and need not be further disclosed herein.

The web site 52 includes a menu field 53 and an explanatory 54. Explanatory field 54 of web page 50 comprises an explanatory section that may be utilized to welcome the user or doctor or other clinician to module 30. Field 54 may be completely customized with data inserted from any field in the database and may also provide links to other pages with this module 30. As a further example, a link may be provided to a statement of privacy policy, which is exceptionally important in the provision of health care services utilizing the Internet. Such a link is shown at 54a. As indicated above, such hypertext links are well known and need not be described further herein. The menu section 53 of web page 50 preferably consists of a plurality of options available to the patient. The number and title of the options is not critical. As shown in FIG. 2, the Menu section 53 includes items and links 53a through 53m. The items and links shown are as follows:

| | |
|---|---|
| 53a | My Health Menu |
| 53b | Health News |
| 53c | My History/Interests |
| 53d | BC/BS-Rx |
| 53e | E-Messages |
| 53f | See a Pharmacist |
| 53g | See a Physician |
| 53h | Medication News |
| 53i | Learn Health Skills |
| 53j | Health Plan/Reminders |
| 53k | My Health Monitor |
| 53l | Health Links |
| 53m | Log off |

Each of these is described below.

Item and link 53a My Health Menu, is a selection frame menu that displays options available to the patient. It will be appreciated that selection and use of this menu item and link gives the patient access to a variety of health services, including news from caregivers, web-based patient education and certification, a health care management regimen, care management reminders and tracking, secure e-messaging, chat and video consultations with a doctor or other clinician, conversational journals, health indicator with graphical feedback, and electronic triage of acute, self-limited illness. Such items and links are exemplary. As other features or services are desired, the menu 53a may be expanded as to accommodate those other features or services. The manner in which the menu 53a is used is described below. It will be appreciated that each item 53b-53m may be accessed by “clicking” on the appropriate entry, which links the user to the stated feature as described below. The technology for such an operation is well known in the art and need not be further disclosed.

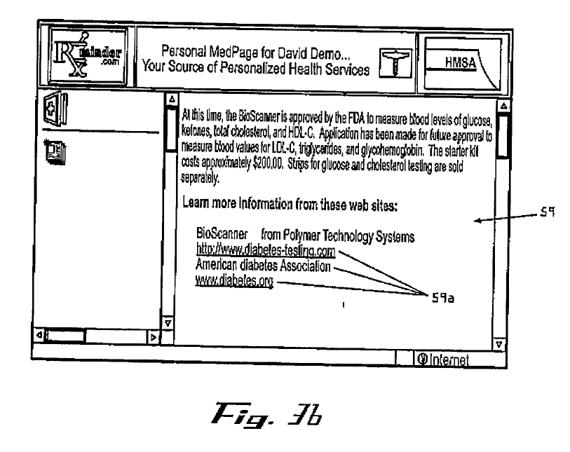

Item 53b, Health News, provides a link to personalized health news concerning a patient's specific conditions. For example, as shown in FIG. 3, an individual patient with diabetes may be provided an article entitled “Living Healthy With Diabetes.” The article would be loaded into this area by a doctor or clinician, who would make certain that the article was applicable to the patient's specific conditions. As shown in FIG. 3, the “Health News” menu preferably provides sub-menus 58a-58e, or sub-links, such as Welcome (58a), Current News (58b), Asthma (58c), High Blood Pressure (58d), and Diabetes (58e) all directed and controlled by selections made by clinicians as described herein. By use of these sub-menus, the patient has the ability to select from information that pertains to the interest of the patient. Such information is displayed in a separate field 59. As shown in field 59 in FIG. 3, an article entitled “Living Healthy With Diabetes” is displayed. Thus, in this example, the patient has “clicked” on the Diabetes sub-menu item 583, and been provided the displayed article. Of course, multiple articles or multiple subjects may be provided. The bottom of field 59 in FIG. 3 shows the end of the identified article, and also displays the identity of other websites 59a that would provide additional information of interest to a patient. It is to be understood that the patient may be only exposed to information related to his or her condition or interest that will enhance on-going awareness of and reinforce the desired behavioral change. Such information may comprise an article, newsletter, journal, or other published material.

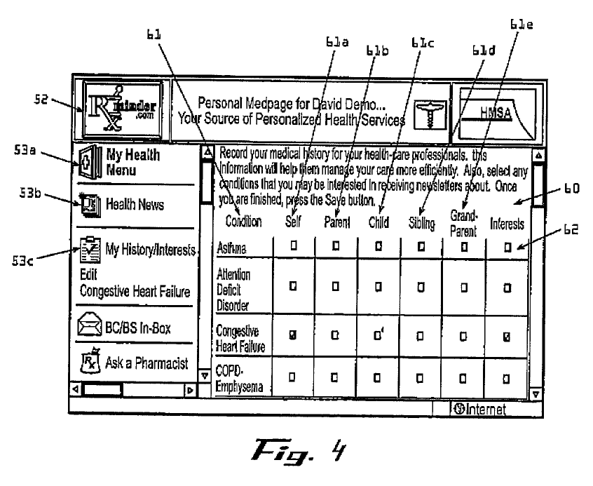

Web page 50 further includes the “My History/Interests” menu item 53c, which provides for recordation of the health history of the particular patient and relatives, and further provides an opportunity for the patient to record interests. Thus, as shown in FIG. 4, this link preferably provides a survey 60 including conditions that may be listed alphabetically or in any suitable menu. The patient completes this survey 60 and saves the results in a conventional, well-known manner. It will further be appreciated that in the Health Menu Area 53, the “My History/Interests” menu item 53c includes an edit sub-menu 61a so that the patient can update this information periodically, as necessary and appropriate. These history and interest data are then made available to the doctor or clinician as described herein to aid in the doctor's or clinician's decision process when interacting with the patient, as well as influence the content and tools and the patient's web page 50 as provided in the patient's module 30. Referring to FIG. 4, the “My History/Interests” item allows this particular patient to record conditions 61 such as “asthma, attention deficit disorder, congestive heart failure, etc.” The patient can, by “clicking” and thus checking boxes, appropriately complete the survey 60. Moreover, information may be provided not only for the patient, but also for a patient's parent, child, sibling, and grandparent (see 61a-e). Finally, if the patient has an interest in any of these conditions, a final column 62 is provided.

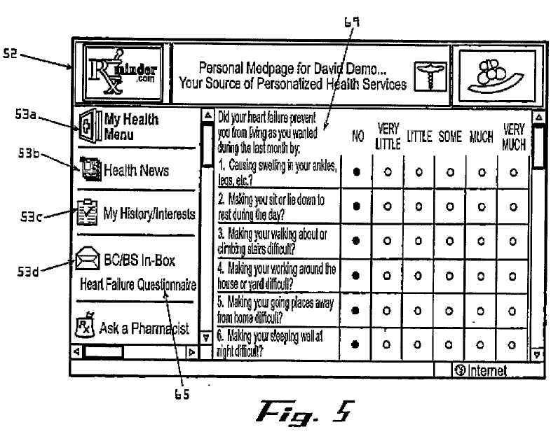

The “BC/BS In Box” menu item 53d of the web page 50 provides for customized health assessment surveys and medical assessments to be performed. See FIG. 5. This menu item 53d provides a customized health assessment survey. The patient may here be provided with a survey directed to a particular health issue. Referring to FIG. 5, a survey form 69 for “Heart Failure” is provided. The specific survey is identified in a sub-menu 65 below the Health Assessment 53d. Such customized surveys, shown at 69 on the web page 50, are presented to the patient at the time to be used and will be highlighted in reminders to the patient at the appropriate time that the survey needs to be completed. If multiple surveys are necessary, each will be listed as a sub-menu item 65. Once completed, saved and submitted (as described in greater detail below), the sub-menu item 65 will disappear. As can be seen in FIG. 5, this health assessment tool provides a series of questions that may be answered on a scale ranging from “no” to “little” to “very much.”

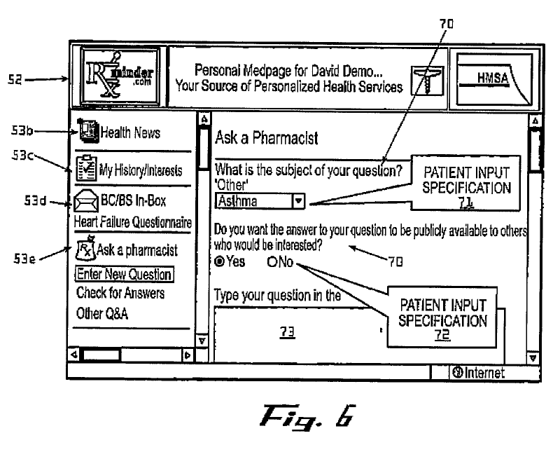

The web page 50 shows “See a Pharmacist” and “See a Physician” menu items 53f and 53g. (Specifically shown in FIG. 8.) These items and links may be preferably combined into a single item entitled “eMessenger,” a trademark denoting a secure and private electronic messaging system combined with a unique conversational journal that stores and organizes all interactions of anyone on the patient care team into conversations by topic, thereby making it straightforward for the patient and the doctor or clinician or any other care team members to research past interactions and also stay abreast of current interactions. Thus, it is to be understood that the electronic messaging system of the present invention provides for patients to communicate, interactively, with their doctors, pharmacists and other clinicians. All communications are preferably done through this bulletin board rather than through a standard public e-mail operation which is not secure. In operation, the patient is provided with a screen prompt that states: “Ask a Pharmacist, What is the subject of your question?” or, “Ask a Physician, What is the subject of your question?” shown generally at 70. See FIG. 6. The patient is further provided an area of the screen 71 within which to type the subject question. As shown, the patient can specify, at position 72, whether a particular question and answer is to remain private. If not, the question and answer may be shared with other patients. When a question or request is posted, the recipient clinician receives a notification via standard e-mail that new information is present in their bulletin board. Turning again to FIG. 6, the patient can type in a question for the doctor, pharmacist or other clinician in the field 73. The sub-menu includes an “Enter New Question” that renews these questions 70 and the field 73. For reference purposes, that sub-menu listing appears in a boxed outline.

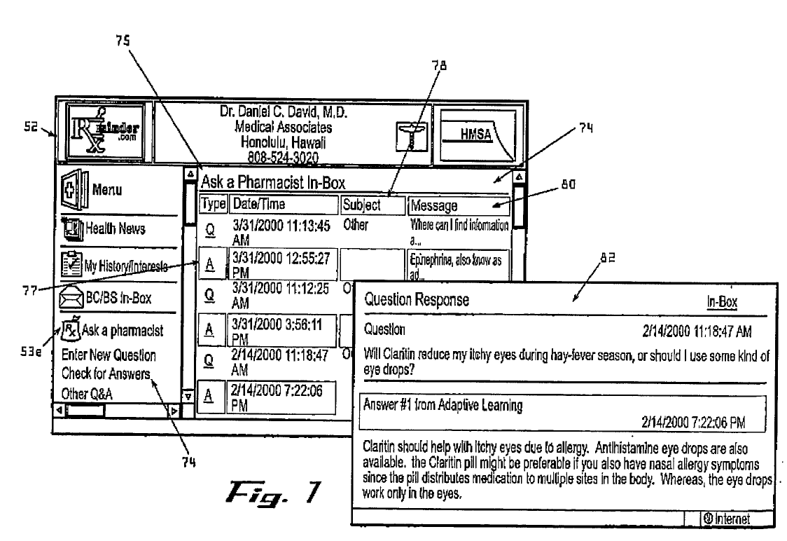

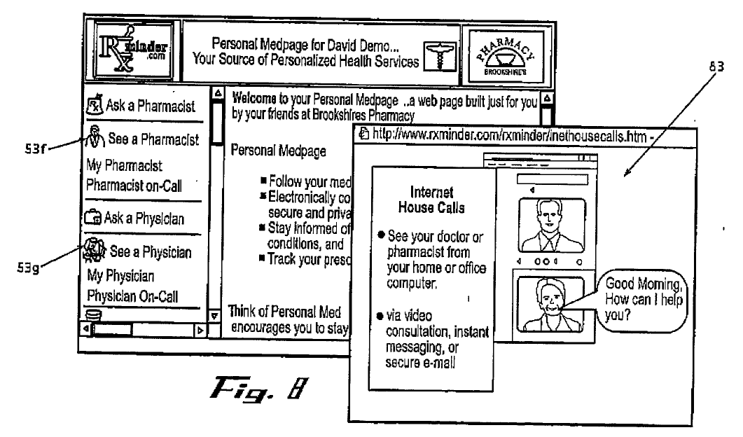

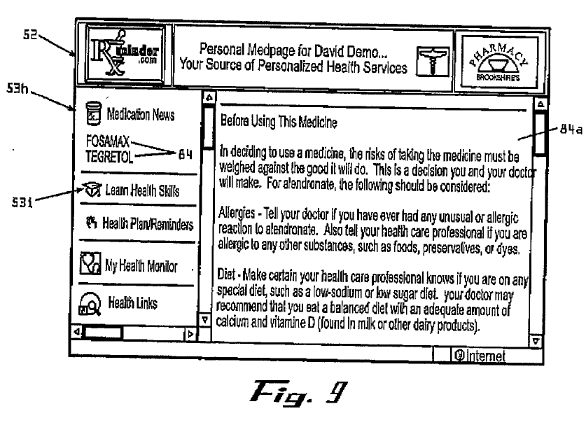

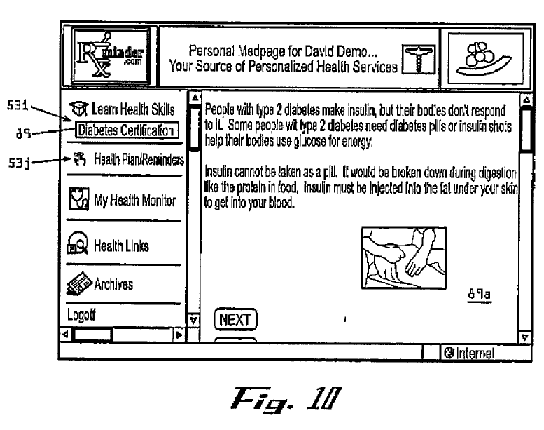

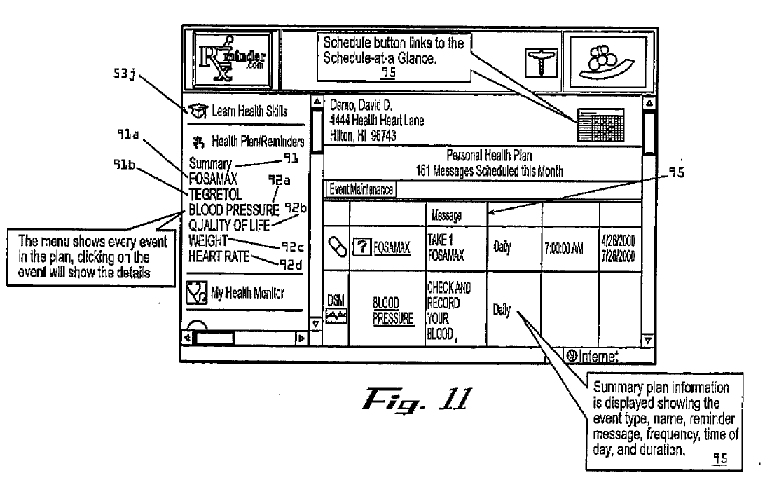

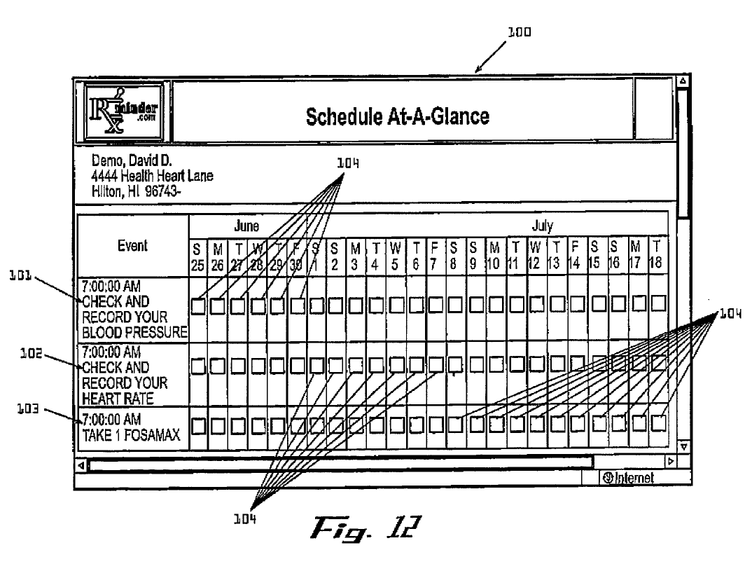

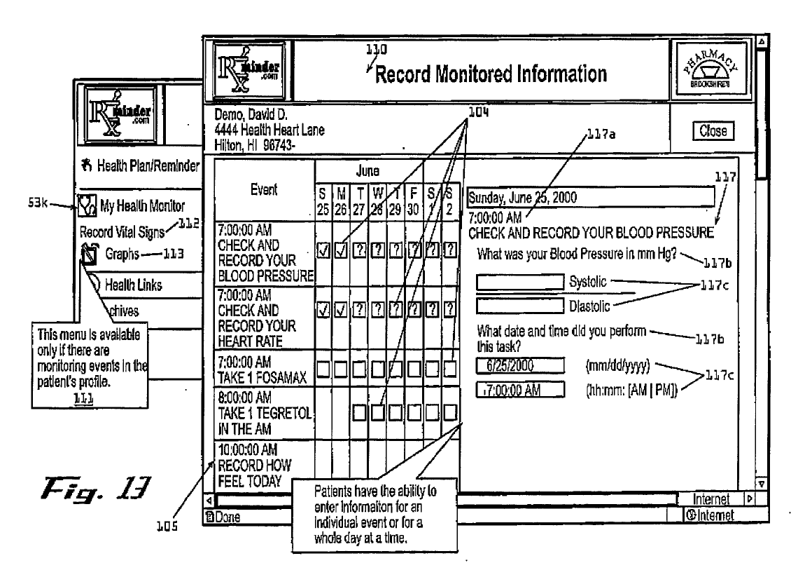

Each patient has his or her own private secure conversational journal on which they can check for answers to their questions, find answers to those questions and to previously asked questions. The sub-menu item “Check For Answers,” shown at 74 in FIG. 7, permits a display of answers to questions raised by the patient. As shown in FIG. 7, a screen report field 74 is provided consisting of the question or “Q” 75, the answer or “A” 77, the “Subject” 78, and a “Message” screen display 80. By clicking on the “Q” 75 or the “A” 77, the patient engages a hypertext link that causes the question to be displayed, see arrow 82 in FIG. 7, separate and apart from the screen report 74.

It is to be understood that, in addition to secure electronic messaging and chat communications, patients, doctors and clinicians are provided the ability to communicate via Internet-based video conferencing. This aspect of the present invention permits the patient and doctor (or other clinician) to see each other on the computer screen. More specifically, as shown at 83 in FIG. 8, a video consultation feature using web cameras and the like may be utilized to link the clinician to the patient. In this manner, the clinician can actually make an electronic “house call” and speak directly with the patient. Video consultation is accomplished by the invention in a manner so as to complete the video link between patient and doctor or clinician with one click on the “Personal MedPage” (patient module 30) and with special packet routing that minimizes video latency and improves image quality. This single “click” video conferencing connection is accomplished in the following manner. When the patient's web browser requests of the server that the patient's Personal Med Page be dynamically built, the server, through a well known web process called Active Server Pages (or by means of any equivalent process), searches the date base for a list of doctors or clinicians to whom the patient is assigned for video conferencing purposes. The Active Server Pages or equivalent process also searches our Internet Locator Service server for a list of doctors or clinicians that are currently logged onto the system and are available for a video conference. The server compares the two lists and prepares a third list of clinicians who are both available for video consultation and assigned to that patient. This third list of available doctors or clinicians is displayed in the requesting patient's dynamically built “Personal MedPage.” The patient, seeing on their “Personal MedPage” the list of doctors or clinicians who are both assigned to the patient and available for video consultation, is then able to click on one of the so listed doctors or clinicians and initiate the video conference connection. When the patient clicks on the so listed doctor or clinician, the special web link represented by the clinician's name on the “Personal MedPage” causes the patient's browser to command the patient's computer to run a video conferencing software application using specific video conferencing address information that is provided by the “Personal MedPage.” The command to run the video conferencing application contains and the addressing and connection information required by the video application to make a successful connection with the single click on the “Personal MedPage.” The person of ordinary skill will further understand that this aspect of the invention is built upon an open, compile-free application environment which combines HTML pages, scripts, and server components to create powerful web-based applications.

The preferred “My Health Menu” item 53a of web page 50 may further include a personalized medication news link 53h. See. FIG. 9. This file contains information regarding medications in a particular patient's profile. Each medication prescribed or otherwise specified for the patient is listed as a sub-menu 84 under the “Medication News” heading 53h. The links dictated by the sub-menu items 84 may, but do not have to, utilize hypertext links to public sources such as WebMD, Mayo Oasis, Health•A to Z, or to proprietary databases such as Gold Standard MultiMedia, USPDF, Facts and Comparisons, Micromedex, and others. Regardless of the source, the present invention builds the search string to find the appropriate data and fetches that data for display in field 84a. Referring in greater detail to FIG. 9, the “Medication News” item identifies two medications, FOSAMAX and TEGETOL, both at 84. By clicking on that sub-menu 84, the patient engages a link that causes a display 84a to appear (as shown in FIG. 9) providing information about the identified drug. By clicking on either of these links 84 (or as many links may be present due to doctor or clinician specification), the screen display 84a is provided that displays information regarding the specific medication. It will be appreciated that the doctor or clinician identifies the appropriate medication to be disclosed and described to the patient. By clicking on the name of the medication in the sub-menu 84, the patient is able to read information regarding the medication and thus become educated regarding its use, side effects, etc.

The preferred “My Health Menu” 53a of web page 50 may further include a “Health Skills” or a “Learn Health Skills” 53i item and link. This feature, shown in FIG. 10, provides links to on-line courses prescribed by the clinician or determined automatically by health regimen templates. As a result, only those courses that are germane and appropriate for the patient are offered. The course may preferably include pre-tests, educational content, and post-tests. As shown in FIG. 10, an example course may be one for a “Diabetes Certification” course, which appears as a sub-menu item 89. Upon taking the pre-test, the patient would be advised of areas or information to be studied and learned. Such information would then be provided in a content display, preferably as shown at 89a in FIG. 10. Once again, it is to be understood that the doctor or clinician would be responsible for determining the content of the link and sub-menu item 89. After reviewing the content display, the post-test validates the patient's learning process, identifies gaps in patient knowledge by means of a report card provided by the communications module 40 to the patient and the clinician so that each can focus on filling gaps in a patient's knowledge with appropriate information or task completion.

The preferred “My Health Menu” 53a further may include a “Health Plan/Reminders” link 53j, a regimen that presents a personal health plan 90 for the patient. The “Health Plan/Reminders” menu heading 53j may preferably provide various sub-menus, such as a “Summary” 91, and medication identification or procedural/check identification information 92. See FIG. 11, which shows an extended Health Plan/Reminders menu 53j, including a Summary 91, a medication identification FOSMAX at 91a, another medication identification (or event) TEGRETOL at 91b, monitoring event or identification for BLOOD PRESSURE at 92a, a monitoring event for QUALITY OF LIFE at 92b, a monitoring event for identification WEIGHT at 92c, and a monitoring event for HEART RATE at 92d. This health plan with reminders is either created for each individual by a doctor or clinician (or agent thereof), or is automatically created by regimen templates created in the clinician module (provider's module 20) described below.

It will be further appreciated that a calendarized schedule, referred to as “Schedule-at-a-Glance,” is provided at 95. In keeping with conventional programming, the schedule 95 of health events preferably provides a link to a unique print-out of the patient's health improvement regimen. For example, as shown in a message display 95 in FIG. 11, summary plan information is displayed showing the event type (take medication, check blood pressure, etc.), name of medication, a reminder message, frequency (e.g., daily), time of day and duration. The preferred display 95 thus provides a device whereby the patient can maintain and monitor his or her progress and medication. As explained below, the professional clinician can also direct the medication of a patient by manipulating the display 95.

Described in yet more detail, FIG. 12 shows one type of organizational format at 100, preferably known as “Schedule-At-A-Glance. This form has been prepared for patient “David D. Demo,” a hypothetical person This format 100 is specifically formatted for printing and shows not only appointments, but also monitoring events 101 and 102 and medication events 103. The format 100 further provides an open box 105 for each day. As shown and described below, this format provides the patient the ability to input and track health events. In a preferred form, the format 100 consists of a thirty (30) day “snapshot” of health related events. By displaying this formatted schedule 100, the patient can both identify events to be completed, and indicate completion of each such event. For example, referring to monitoring event 101, “700:00 AM CHECK AND RECORD YOUR BLOOD PRESSURE,” a series of boxes 104 are provided. By “clicking” on a particular box, the patient indicates and confirms that the subject task has been completed.

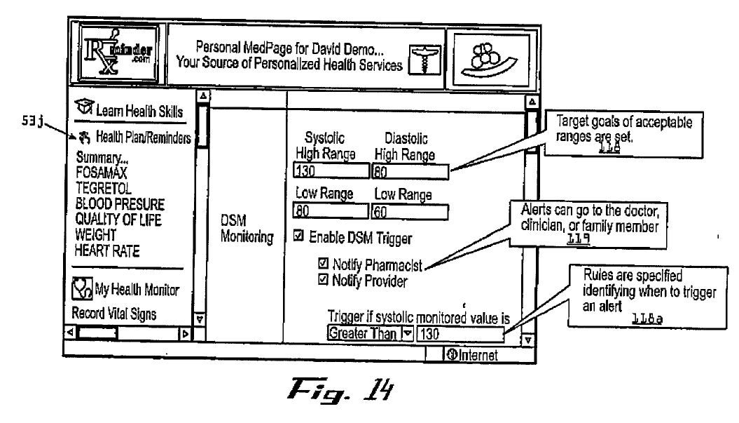

Referring to FIG. 14, it is to be understood that the web page 50, in the Health Plan or regimen link 53j, may provide for the doctor or clinician to set target goals of acceptable or preferred health, such as the acceptable range of systolic and diastolic ranges 188. Moreover, the preferred embodiment of the invention includes a “DSM Trigger” or disease management trigger event. For example, if the systolic monitored reading exceeds 130 (see 118a), then an alert 119 may be enabled such that a pharmacist, another health care provider (clinician or otherwise), is notified. FIG. 14 exemplifies such features of this preferred embodiment.

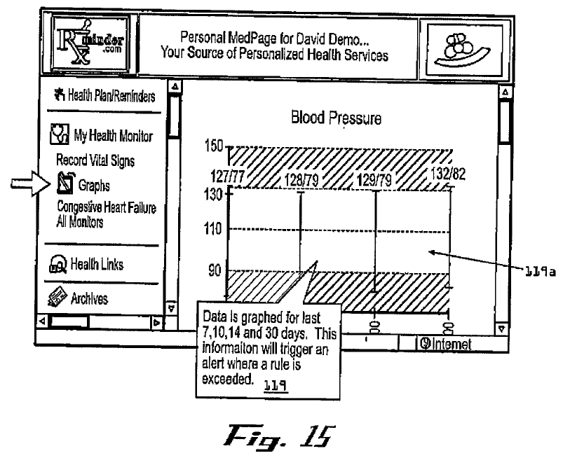

The preferred “My Health Menu” 53a may further include a “My Health Monitor” item and link 53k, as shown in FIG. 13. This feature of the present invention preferably works in conjunction with the Health Planner and “Schedule-at-a-glance” organizational format 100 shown in FIG. 12. Referring to FIG. 13, the same format may be used with the revised heading “Record Monitored Information,” shown generally at 110, and prepared for David D. Demo, a hypothetical person. Although it is not critical that the same display format 100 be used in both the “Schedule-At-A-Glance” portion of Health Plan/Reminders 53j and My Health Monitor 53k, it is preferable to utilize the same or similar formats to insure that the patient is not confused. The menu items section 53 of the web page 50 is preferably made available to the patient only if there are monitoring or medication events in the patient's profile, as indicated at 111. If so, the menu items such as “RECORD VITAL SIGNS” and “GRAPHS,” shown at 112 and 113 respectively, appear under the menu item “My Health Monitor” 53k. By “clicking” on the “RECORD VITAL SIGNS” item 112, the patient causes a “Record Monitored Information” display chart 115 to be provided. The patient, using the display chart 115, has the ability to enter information for a specific event (such as “7:00:00 AM CHECK AND RECORD YOUR BLOOD PRESSURE) and for an entire day. For a specific event, the patient clicks on the appropriate box, which cause a monitoring event display 117 to appear in a superimposed fashion on top of the display chart 115. The event display 117 identifies the date 117a, the event 117b, and provides appropriate fields 117c for input of the relevant information. It will be appreciated that these fields and the prompt questions may be amended and displayed as necessary for the specific event at issue. Further, as shown in FIG. 15, the information as recorded by the patient may be provided on a graph 119a. Data is preferably graphed for discrete periods of time and an alert trigger may be enabled as shown at 119.

With reference to recording monitored information in FIG. 13, patients are also able to enter information for an entire day by “clicking” on the day (such as “S 18”). Patients are provided with a display that provides a reminder message, such as CHECK AND RECORD YOUR BLOOD PRESSURE. The patient, after performing the identified task, then logs in the results where indicated at the box in the display. The patient also logs in the date and time where indicated at 117c in the display. Once entered, the appropriate box 104 is filled with a check to indicate task completion.

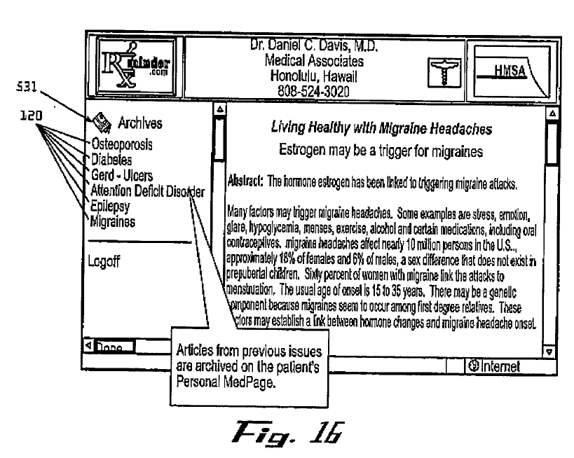

Referring to FIG. 16, the preferred menu 53a may also include an “Archives” link 531 which, as shown in FIG. 16, includes articles from previous issues or other sources that are maintained on the patient's web page. Thus, as shown in FIG. 16, this particular patient has retained or archived an article entitled “Living Healthy with Migraine Headaches.” Moreover, sub-menu Archives 531 may be further classified by subject matter and appropriate links established, as shown at 120.

Finally to exit web page 50, the patient is provided with a “Logoff” link 53m. Such links are conventional and need not be further described herein.

It is to be appreciated that the foregoing describes in detail the patient's or user's interface with the invented system and method. Based on the patient's condition and medication profile, which is preferably stored in a database, this web-based (web page) interface provides the patient with a customized and personalized web page that allows the patient to access a variety of health services, which are described in detail hereinbelow. This personalized web page thus acts as an electronic “coach” that, by means of the foregoing described interactive menu, provides a medical regimen to be performed by the patient. This menu further provides for reminders to be sent to the patient, via various industry standard protocols to various receiving devices (as such, these reminders may be sent to a computer, pager, wireless Personal Digital Assistant (PDA), cellular phone, etc.). This menu further provides for direct communication with a clinician, either by a private and secure e-mail-like connection, chat or video. Moreover, as will be understood by reading the following, this entire regimen can and preferably is directed by a professional health care provider or his agent. The services that can be offered by that clinician are as follows.

First, the preferred embodiment of the present invention provides for personalized, web-based patient education certification. This aspect of the invention provides links to patient education courses regarding that patient's medications and disease state regimen. By taking such courses, the patient's knowledge and resulting confidence to participate in his or her own health care procedures is enhanced. Simultaneously, these courses (and their successful completion) provide the doctor or clinician with some assurance that the patient has learned necessary information to effectively conduct the regimen.

Described in greater detail, the patient certification process does pre-testing of patient understanding, presentation of patient education material, and post-testing necessary to insure that the patient has mastered the material necessary for performance of the health care task. In its preferred form, the invention provides a “report card” or other progress monitoring device to be sent to the clinician in an industry standard format and placed in a patient's medical historical records. This information can be used by a clinician to determine any troubling areas of a patient's knowledge base and improve that weakness by further education as the clinician deems appropriate under the circumstances. Optionally, the clinician (or agent thereof) and the patient are able to have an electronic conversation regarding any identified gap. In addition to individual patient data about learning validation, the present invention collects and aggregates data for population management whereby the clinician, health sponsor, or employer can receive information indicating the trouble spots across an entire population so that better decisions can be made as to where additional investments in health initiatives should be made for specific patient populations.

It is to be understood that this web-based certification process is a substantial improvement in the art of providing health care. It is known for physicians, nurses, pharmacists and other health care providers, employers and insurers to provide written materials (a brochure, leaflet, etc.) to a patient regarding a particular disease, treatment, pharmaceutical, etc. or to provide an Internet address to a patient so that the patient may access information about a particular disease, condition, etc. Under such conditions, the clinician and relevant others have typically no way of knowing whether the patient received, read or understood such materials. In contrast, the present invention provides an Internet-based method that determines a patient's initial understanding level by means of a pre-test, educates the patient by provision of targeted links to educational materials (as directed by a clinician or the agent thereof), and determines the patient's level of understanding by means of a post-test.

The preferred invention may further provide personalized health-related newsletters for on-going patient education and awareness of medications, diseases, conditions and other related topics. Such newsletters are preferably selected and published by the patient's health care provider or from original content supplied by numerous third party sources as identified hereinabove by means of a Clinician Publisher Module.

As described above, these services are preferably provided, selected, monitored or in some other way managed by a professional health care provider. Accordingly, the present invention further includes a module directed to the clinician to provide a unique, Internet-based health planner and monitor of significant health related events, preferably with wireless or other appropriate communications devices so as to encourage new behavior in the patient's being treated. The clinician's view of the present invention would include the long-term and statistically significant monitoring of a wide variety of disease states so as to better train the patient to address those needs. Patients with chronic ailments are a good example of a patient group to benefit from the present invention. The more than 90 million Americans with diabetes, asthma, congestive heart failure, and other chronic diseases would be prime candidates to receive the benefit of the present invention. Thus, the preferred embodiment offers the clinician an array of Internet-based tools by which to positively influence patient behavior between traditional episodes of care.

The clinician module 20 of the present invention preferably provides a variety of features that allow the clinician to direct the patient and to interact with the patient to improve the level of services offered and provided. The clinician module 20 provides the doctor or clinician with a variety of care management tools that enables the doctor (or clinician) to educate his or her patients, to monitor the patient's health (independently of and in addition to traditional episodes of care) and communicate with the patient and other members of the care team.

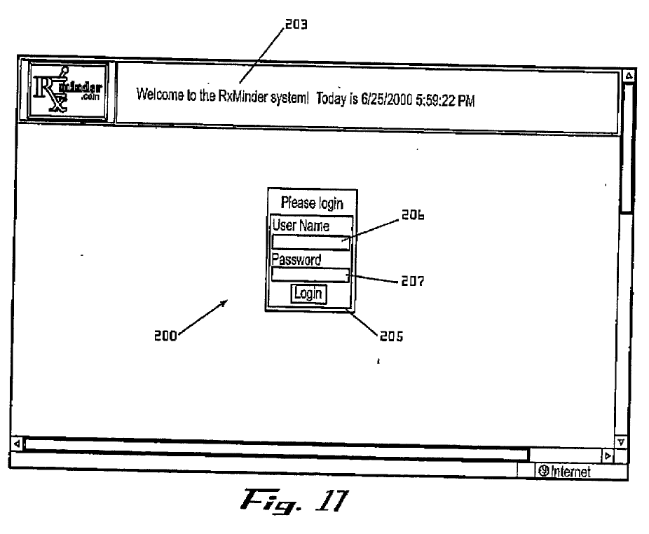

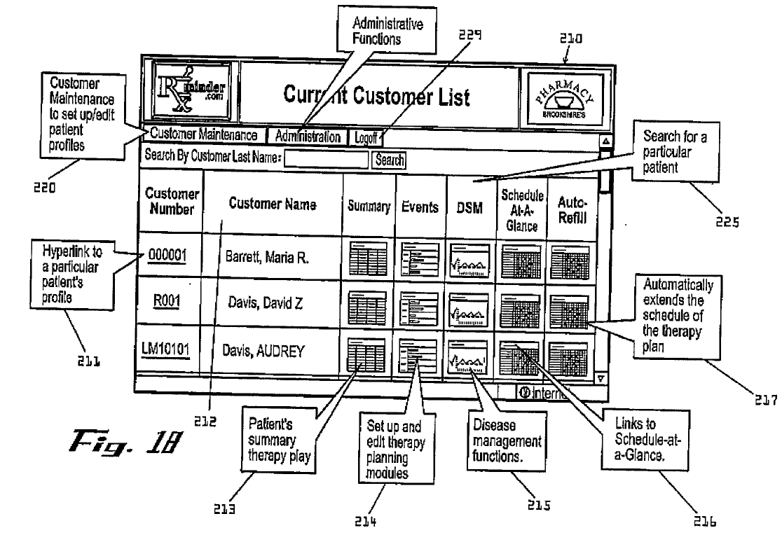

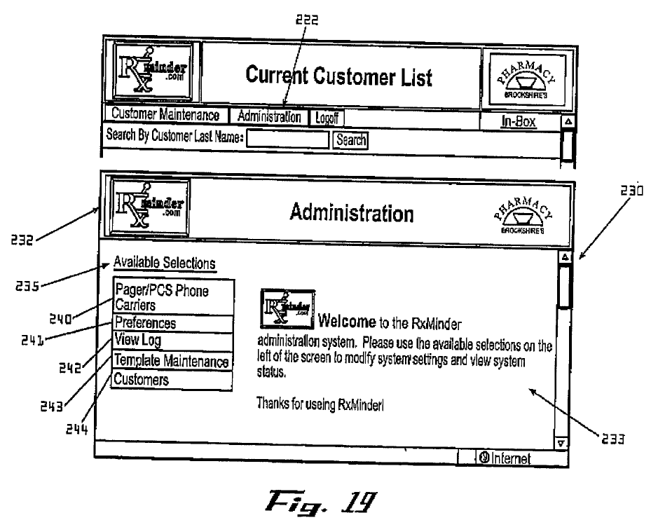

At the outset, the doctor or clinician is provided with a log on protocol and an appropriate screen display. Referring to FIG. 17, the disclosed log on display screen 200 is shown. The screen 200 provides a header 203 that welcomes the doctor or clinician and informs of the date and time. The log on process utilizes a log in field 205 that includes the “User Name” field 206 and the “Password” field 207. Such a procedure and fields are known in the art. As is conventional, the doctor or clinician would divine his or her own password, and the system would accommodate and require re-entry of that password to permit the doctor (or clinician) to gain access to the module 20. If desired, the invention contemplates that the password may need to be changed periodically for security reasons.

Upon entering the clinician module 20, the doctor or clinician is first provided with a “Current Customer List” screen display 210, shown in FIG. 18. The preferred display 210 provides a “Customer Number” column 211, a Customer Name” column 212, a “Summary” column 213, an “Events” column 214, a “DSM” or disease management column 215, a “Schedule” column 216 and an “Auto-Refill” column 217. Each of these is described in greater detail below. The preferred Current Customer List display 210 further includes links entitled “Customer Maintenance” 220 and “Administration” 222. The preferred display 210 further includes a “Search” icon 225 and a field area 227 for entry of a particular patient name. The preferred display further includes a “Log off” link 229. Each of these are also described hereinbelow.

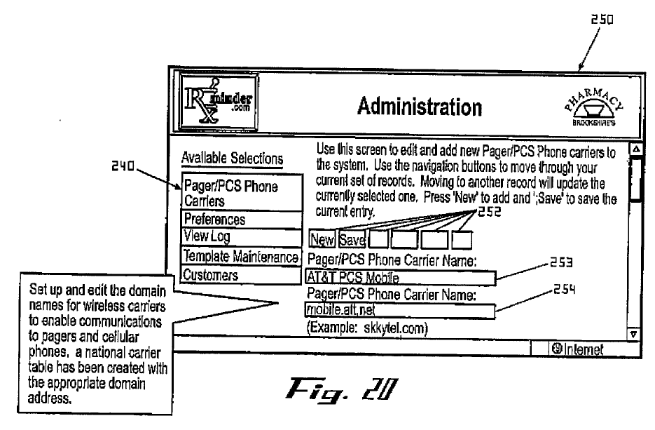

FIG. 19 shows a preferred “Administration” display screen 230, obtained by clicking on the “Administration” link 222 shown in FIG. 18. The display screen 230 includes a title bar 232, a text field 233 and an “Available Selections” menu 235. The menu 235 includes five sub-menu items, namely—“Pager/PCS Phone Carriers” 240, “Preferences” 241, “View Log” 242, “Template Maintenance” 243 and “Customers” 244. FIG. 20 shows a preferred display screen 250 for the “Pager/PCS Phone Carriers” link 240. This screen provides for the editing and addition of carriers to the system. The doctor or clinician uses this screen 250, which includes function buttons referenced generally at 252 to enable communications to pagers and cellular devices. The module 20 includes the ability to store and retrieve a carrier's name and Internet domain. Thus, two fields 253 and 254 are provided for entry of this information.

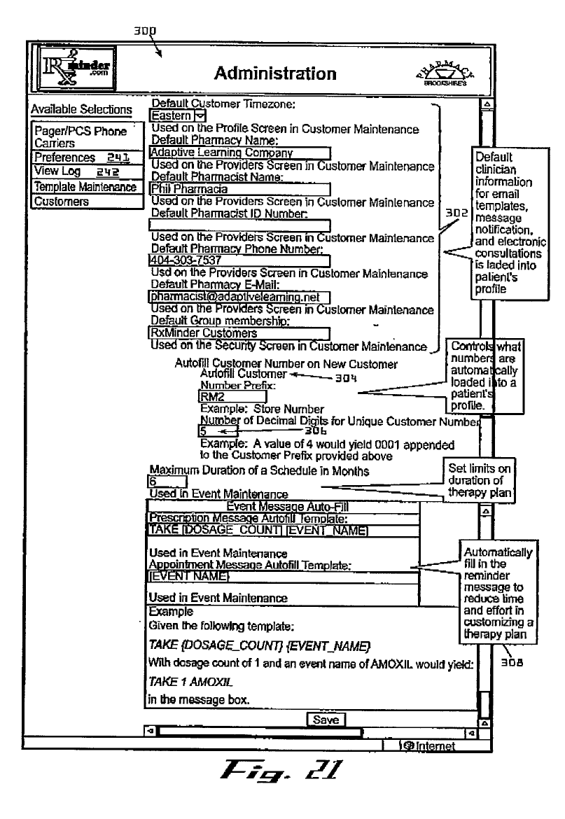

FIG. 21 shows the “preferences” screen display at 300. These preferences 300 provide the doctor or clinician with various options for referencing other care team members, such as a pharmacist's name or another clinician's location. By using HTML programming “cookies,” which are known in the art, this application of the module 20 will save information to the clinician's computer for later use. As shown generally at arrow 302 in FIG. 21, default clinician information for e-mail templates, message notification and electronic consultation is loaded into the patient's profile. An “Autofill Customer Number Prefix” is shown generally at 304, which controls the numbers that are automatically loaded into a patient's profile. A schedule duration field 306 is provided, which sets the limits of a therapy plan's duration. The example of “6” months is given. Yet further, the Administration Preference screen display 300 includes an “Event Message Auto-Fill” field, indicated generally at 308 in FIG. 21. This field is automatically completed (by the module 20 programming) with reminder messages and the like for the doctor or clinician. This feature thereby reduces the time and effort made by the doctor or clinician in customizing a therapy plan for a particular patient.

The administration sub-menu further provides a “View Log” screen display 320, which enables the doctor or clinician to review and manipulate (for example, by sorting) a log of messages sent to the server from any and all of the therapy plans. Referring to FIG. 22, the preferred “View Log” screen 320 includes a date and time column 322, a customer number column 324, and a message column 325. The message column includes not only a description of the specified event, but also the recipient address, a success indicator and/or error message. Each is shown in the example message column in FIG. 22.

The Administration sub-menu further provides a “Template Maintenance” screen display 340, which is used for the creation and maintenance of care management protocols. As shown in FIG. 23, a “Congestive Heart Failure” template 342 is provided. As shown, this template may be selected from a variety of available templates, which may be called to the screen display 340 by means of a scrolling curser 343. Returning to the given example, the template 342 includes Monitoring Events such as “Blood Pressure” and Medication Events such as “Fosamax.” The doctor or clinician may create a standard therapy plan by “clicking” on such indicators.

As described above, the Current Customer List includes a “Customer Maintenance” feature, which is shown in FIG. 24. By clicking on the “Customer Maintenance” icon 220, a “Customer Maintenance” screen display 350 is provided, preferably as shown in FIG. 24. The preferred Customer Maintenance display screen 350 includes various items. An “Information” item 352 is preferably provided to accept and store patient demographic information. A “Security” item or link 354 is preferably provided to set and utilize user name and passwords as set out hereinabove. A “MedPage” item or link 356 is preferably provided to permit a link to the patient module 30 and the web page 50 for the subject patient. A “Messenger” item or link 358 is provided to specify or retrieve communications addresses, such as wireless or e-mail address. A “Providers” item or link 358 is provided to specify the provider information for routing of communications between the patient and the doctor or clinician. A “Profile” item or link 360 is provided to specify the time zone applicable and to give access to default caregiver information.

The “Customer Maintenance” screen display 350 further shows an example display for “David Demo,” including fields for name, address, social security number, birth date, phone number and emergency contact. This preferably constitutes the demographic information to be maintained in the Customer Maintenance database. See FIG. 24.

FIG. 25 shows a “Security” screen display 380. This feature of the present invention provides for the doctor or clinician to set certain security parameters in execution of the treatment plan. The preferred display 380 includes a customer number field 383, a user name field 385, a password field 387, a “retype” password field 389 and a group messenger field. By operation of these fields, the module 20 permits the doctor or clinician to determine whether the subject patient can log on to his or her web page 50, provide a unique user name (assigned by the doctor, clinician or a system administrator), assign a password and identify any relevant group or population to which the patient may belong.

FIG. 26 shows the “MedPage” display screen 400. The preferred display 400 provides a customer number field 402, an information source field 404, a “modification” field 406 and a disease state category field 408. These fields allow the doctor or clinician to identify the publisher or editor of relevant information (such as a newsletter) at 404, preclude a patient from editing or amending his or her therapy plan at 406, and obtain initial settings for customer interest in a particular disease state so as to permit the clinician to select and direct that appropriate educational materials are utilized by the patient.

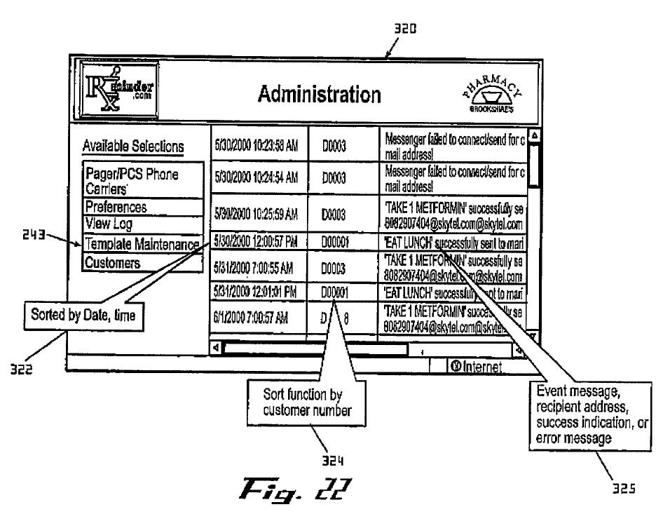

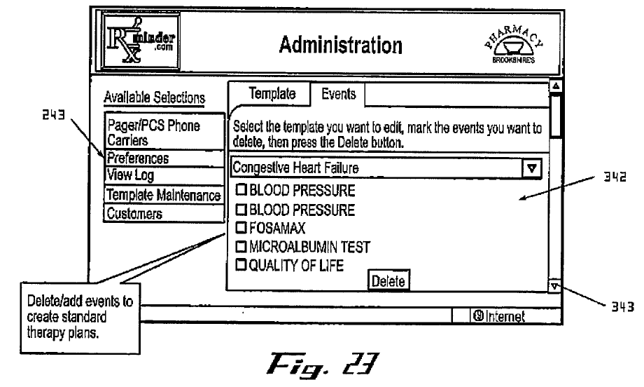

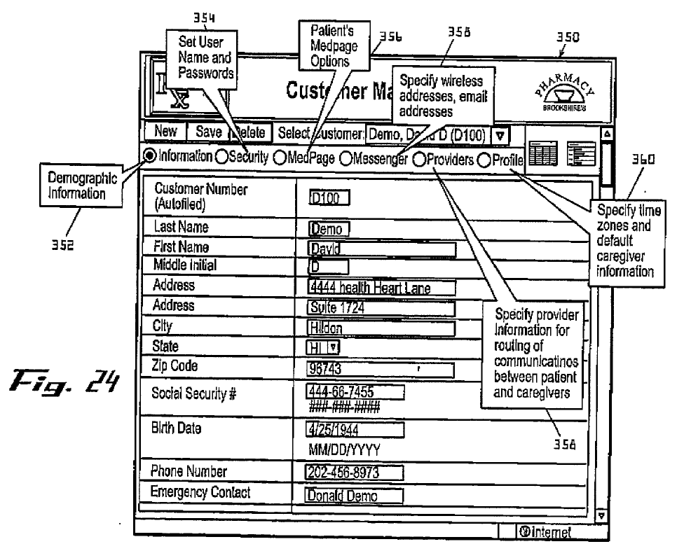

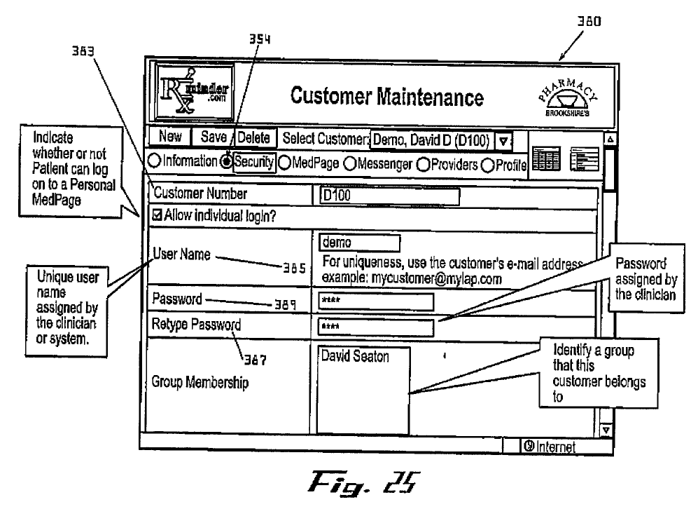

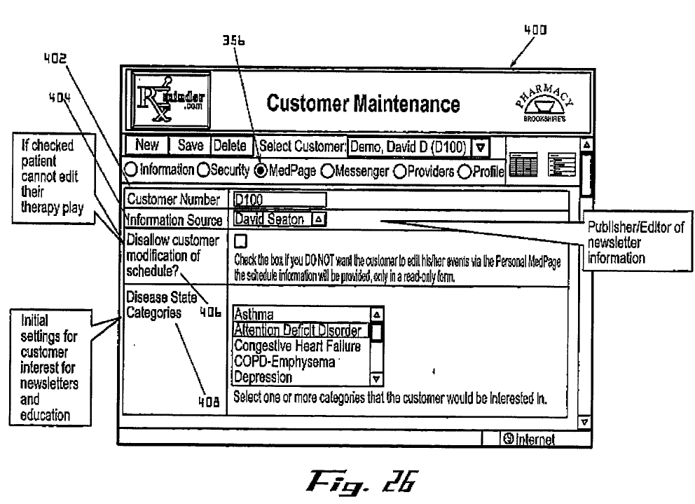

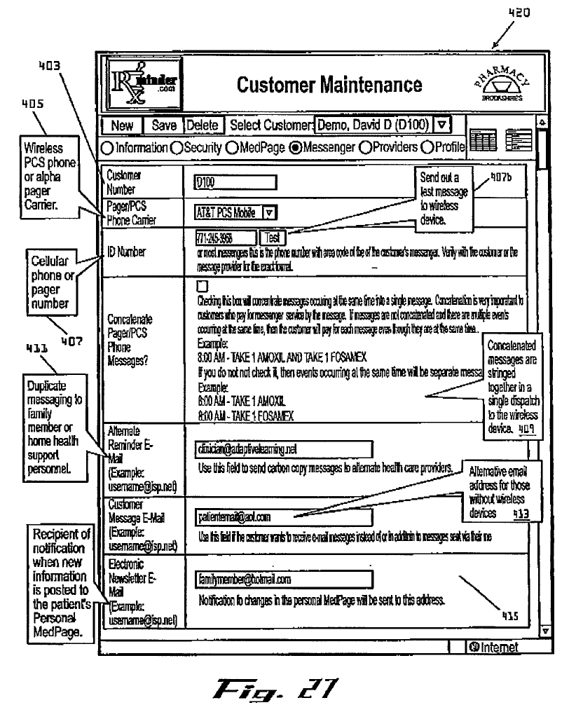

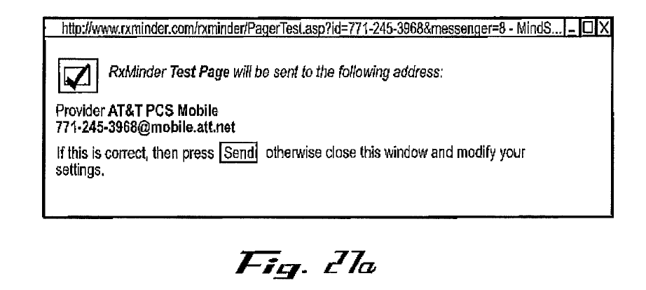

FIG. 27 shows the “Messenger” display screen 420. The preferred display 400 provides a customer field 403, a pager/pcs phone carrier field and menu selection field 405, an “ID Number” field 407, including a “test” feature, a concatenate message field 409, an alternate reminder field 411, a customer message field 413 and an electronic newsletter field 415. The customer field 413 matches the earlier described customer field and is for reference purposes. The pager/pcs field 405 identifies the particular wire PCS phone or alpha pager carrier to be utilized to make the transmission. In this identification, the module 20 includes programming that causes the referenced carrier to be utilized for the subject transmission. such programming is known in the art and need not be further described. The ID Number field 407 includes a sub-field that displays the subject telephone number 407a and includes a “test” icon 407b. The test icon 407b permits the doctor or clinician to send out a test message, an example of which is shown in FIG. 27a. As shown therein, the test message identifies the carrier provider and the address (domain) to which the message is to be sent.

Returning to FIG. 27, the display 400 further includes a concatenation field 409 that provides for concatenated messages to be strung together in a single dispatch to the wireless device. In this way, the doctor or clinician receives and reviews a historical perspective of the communications that can be most helpful in making further treatment decisions. The display 400 further includes an alternate e-mail function at 411 whereby a duplicate subject message can be sent to a patient's family member or any other concerned individual, all at the doctor's or clinician's discretion. Thus, the module 20 provides for storage and retrieval of not only customer information, but also persons associated with the customer that may assist in the provision or completion of a therapy plan.

Display 400 further includes the customer message e-mail field 413 that provides for a conventional electronic communication to be sent to a customer outside of the messaging system of the present invention. This field 413 provides for a traditional, non-secure transmission that can be used if a customer wants to receive such a communication in addition to or in lieu of the “e-Messenger” system disclosed hereinabove. This field may also be necessary if the patient does not have a wireless device by which to receive a reminder. The display 400 further includes an electronic newsletter e-mail field 415 which provides the clinician or doctor with notification of the posting of new information to a patient's personal web page 50.

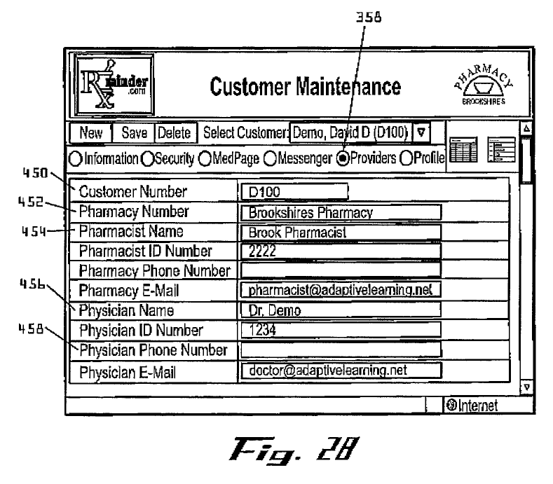

FIG. 28 shows a screen display 500 containing the “provider” settings 358. These settings are used by the personal interest filter to build the patient's web page 50. For example, if there is an entry in the clinician/pharmacist e-mail field, the “Ask a Pharmacist” button will appear as a menu item. Otherwise, it will not. The intelligent health messenger also uses this information to route notifications and DSM (disease management) alerts to the appropriate individuals. As shown in FIG. 28, the providers list includes references for the customer number, pharmacy name; pharmacist name, ID number, e-mail address, physician's name, ID number, phone number, e-mail address, etc. This screen therefore includes fields such as customer name 450, pharmacy name 452, pharmacist name 454, physician name 456, and physician phone number 458. Of course, yet other provider information can be provided pursuant to a doctor's or clinician's desire.

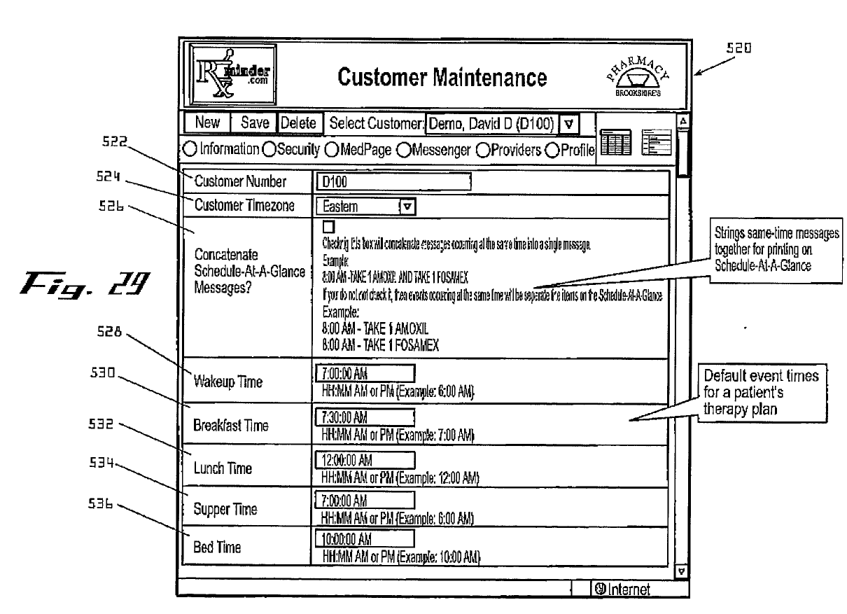

FIG. 29 shows the preferred customer maintenance profile display screen 520. This sheet includes yet further patient information and can be customized as need be. Thus, for example, the display 520 provides the customer number 522, the customer time zone 524, a concatenation schedule that preferably strings same-time messages together for printing or review 526, a wake-up time field 528, a breakfast time field 530, a lunch time field 532, a supper time field 534 and a bedtime field 536. Other fields may be programmed as desired to provide a profile that is of assistance to the doctor or clinician in establishing and reviewing a patient's therapy plan.

One preferred feature is, as discussed above, a template-based individualized therapy or care plan. This plan may consider a range of activities, including a schedule for daily medications, self-monitoring events such as measuring peak flow rate for asthma, blood sugar for diabetes, blood pressure, weight, immunizations, lab tests, and any other event deemed necessary or worthwhile by the doctor or clinician. Multiple templates may be created for any condition, illness or combination thereof and automatically assigned to a homogeneous strata of patients to provide a consistency of care across patient populations with specific conditions. Such a feature therefore not only insures consistency, it allows the clinician to track the progress of an individual patient and compare that progress to others with similar circumstances.

A second preferred feature, as also discussed above, is the “Schedule-at-a-Glance” format. This format is preferably a monthly snapshot of health related activities and events. As shown in FIG. 13, the format provides an “event” column, a month identifier and multiple day identifiers. The event column includes both a description of the event and a time entry. Each event defines a row and an entry box is provided at the intersection of each said row and a day identification column. As the activity or event is completed, the patient “checks” the appropriate box. Thus, from any device by which the clinician may gain access to the Internet, the clinician can review the patient's progress to be certain that prescribed activities or events are being completed in a timely manner. These patient-entered health indicators can then be monitored, tracked and escalated as necessary by the doctor, pharmacist or other caregiver managing the patients health care program.

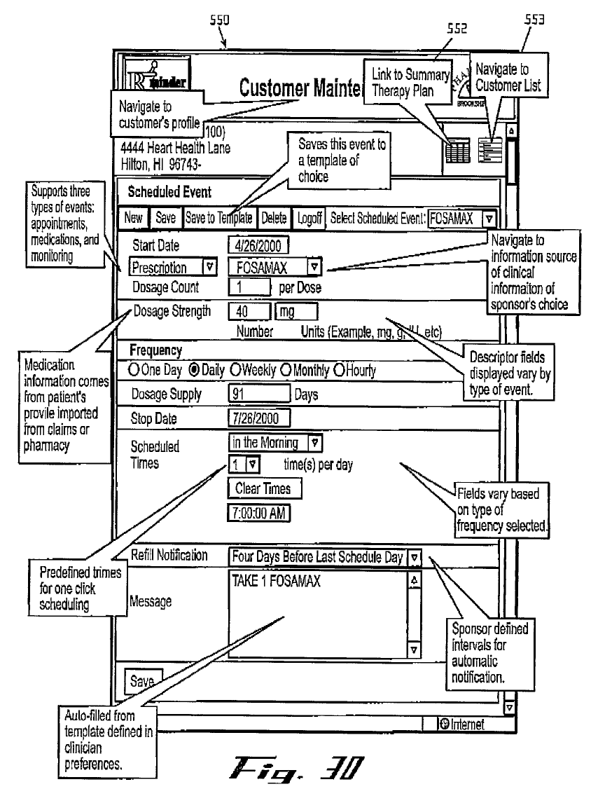

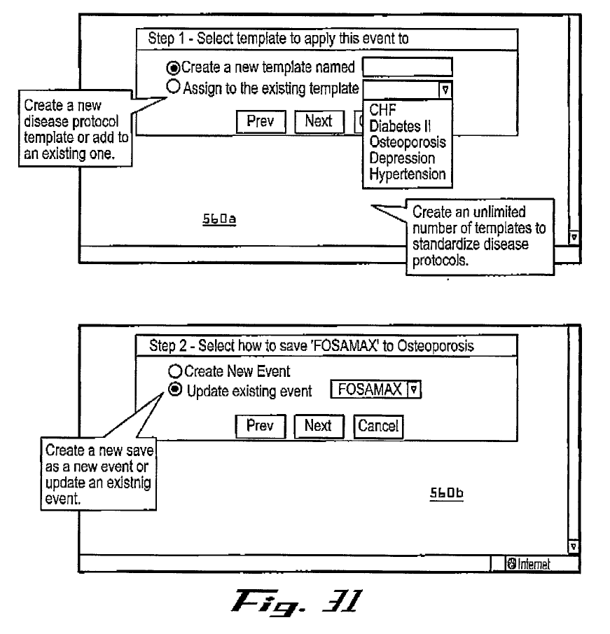

FIG. 30 shows a customer profile screen 550. This screen permits and facilitates the amendment to and of a patient's individual therapy plan or regimen. Thus, screen 550 may be obtained by manipulation of the current customer list screen 210 by, for example, clicking on the customer number 211. As shown in FIG. 30, screen 550 allows the doctor or clinician to a customer's profile, including a link to the patient's summary therapy plan 552 and back to the current customer list 553. The screen 550 supports various events, including appointments, medications and monitoring, generally indicated at 555. The patient's medication information may be imported on a pharmacy system or may be obtained from the patient's profile. It is to be understood that other fields and information may be provided and programmed accordingly. A preferred feature from a doctor's or clinician's perspective is a refill notification field 557 and a message field 558, which are able to provide automatic notification to both patient and pharmacy regarding medication procedure. FIG. 31 shows a preferred screen display at 560a and 560b for creating a new disease protocol template (or adding to an existing template) and creating a new event or update an existing event.

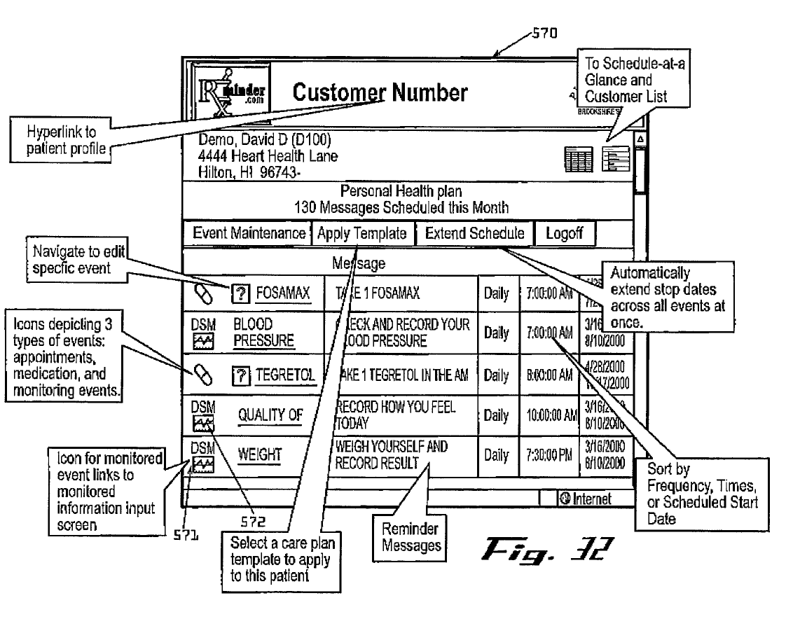

FIG. 32 shows a personal health plan screen 570 that permits the doctor, clinician or system administrator to review a patient's health regimen. As shown, icons are provided in a first column 571 depicting the three basic types of events: appointments, medications and monitoring events. The icon “DSM (Stylized),” shown generally at 572, is the icon for monitored event links to monitored information input screens. Thus, by clicking on the icon 571 permits the doctor or clinician to review graphed information as monitored through the course of treatment.

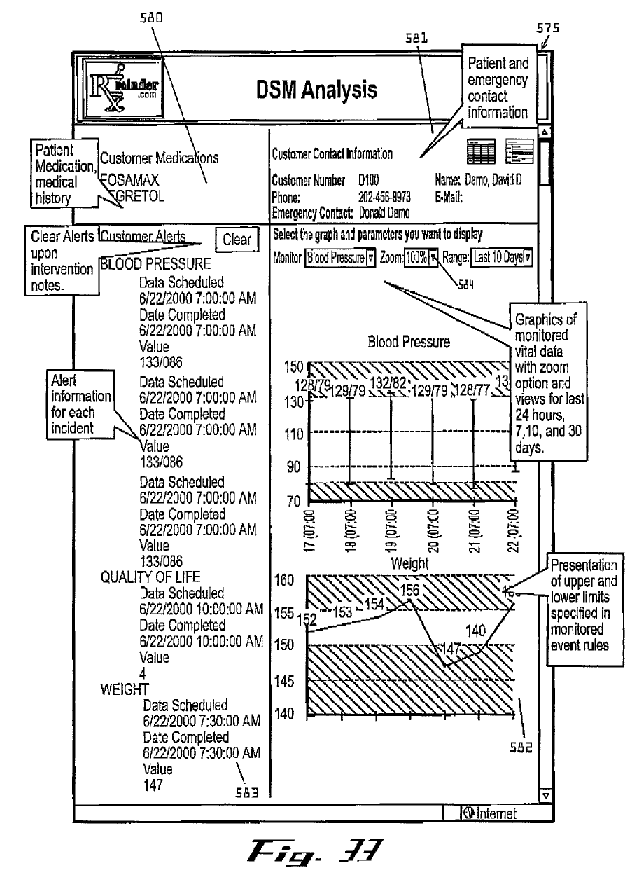

An example of such a monitoring screen is shown in FIG. 33, which is entitled “DSM Analysis.” This screen, indicated generally at 575, includes a patient medication and medical history field 580, a patient and emergency contact information field 581, a graphing or information field 582, and an alert field 583. The information in these fields, as well as the information required by these fields, may vary as desired by the doctor or clinician. As shown, the field 582 displays graphics of monitored patient data for discrete periods of time, such as 1, 7, 10 and 30 days. That information may be viewed more critically by a zoom feature 584. Moreover, additional graphing (or charts) may be provided such as the second presentation in field 582. It is to be appreciated that the screen display 575 allows a doctor or clinician to not only review patient history, but to also be aware and direct new alerts or other regime and treatment events as necessary.

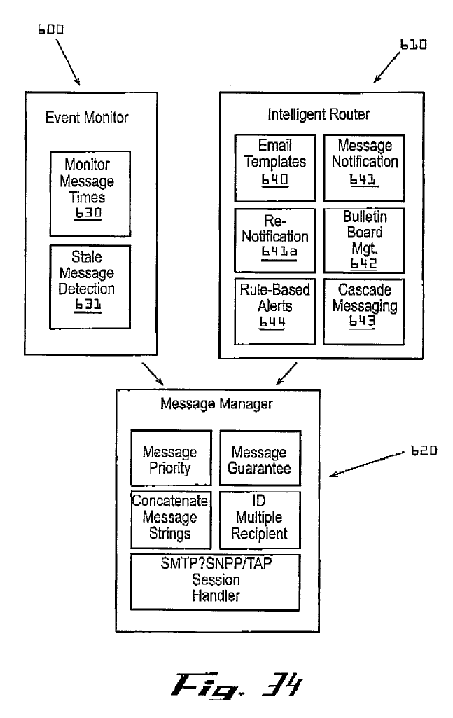

Yet another preferred feature of the present invention is reminder, notification and alert messaging. As explained above, the present invention provides a private messaging system that avoids the inherent primary drawback of conventional e-mail. This messaging system provides for the infrastructure to facilitate interactive communication by and between all users of the invention. As shown in FIG. 34, the messaging system consists of three major components: (1) the Event Monitor 600; (2) the Intelligent Router 610; and (3) the Message Manager 620. These devices 600, 610 and 620 may be servers that are programmed in any suitable computer language to fulfill the following task assignments.

The Event Monitor 600 generates scheduled messages based upon input from the therapy or care plans described above. The Event Monitor 600 therefore continuously monitors all pending therapy plans to identify trigger events messages, as indicated by a “Monitor Message Times” descriptor 630. A trigger event message is an event reminder message associated with a health event with a scheduled time that is in the past but has yet to be dispatched. The event monitor 600 determines if the same messages are intended for multiple users in what is herein referred to as “shadow” messaging. Shadow messaging allows an observer to receive that message at the same time it is received by the patient so that an observer can note the patient's reaction to a particular message without being noticed. The Event monitor 600 simultaneously identifies messages that have become stale. A stale message is a trigger event message that is older than a pre-selected number of minutes (“N”), or any other appropriate time measurement (second, hours, etc.), specified by either the clinician or a system administrator. Stale messages are deleted by the Event Monitor 600, as indicated by item 631.

The Intelligent Router 610 controls all unscheduled communications between parties. It therefore controls communications between the patient and the clinician, between clinicians, and from the system to all users. The Intelligent Router 610 preferably consists of several components, including e-mail templatization 640, message notification 641, patient centric conversational journal management 642, cascade messaging 643, and disease state monitor alerts. The e-mail templatization 640 feature is the capability to customize any message routed to any participant. Accordingly, the message can include static text, dynamic information from the system database, and internet links via universal resource locators (URL's).

The preferred message notification feature 641 includes the building of appropriate message strings based on the e-mail template, sending the message to either the server, checking for errors, and logging the results in the appropriate database locations. This feature includes message “re-notification”, which refers to the process of sending multiple notices to the same individuals at intervals set by a system administrator. It is preferred that an unlimited number of re-notification messages may be sent 641a. However, once a message is cascaded to the next recipient (see below), no additional notification will be sent to the previous recipient.

The patient centric conversational journal 642 is a novel private bulletin board. Communications between the patient and the clinician, and between clinicians, are accomplished through use of the patient's private bulletin board. All content, such as questions, answers and instructions, remain on the patients' private journal server but can only be accessed by a patient, or authorized doctors and clinicians. Because the content of these communications never leaves the server, this architecture reduces all possibility of mis-routing private patient information over the internet. The criticality of this feature is to be appreciated in that this alternative to e-mail is HIPAA compliant. It is known to provide encryption of e-mail, or other such security devices that render conventional e-mail less susceptible to public access is cumbersome and difficult to implement. The present messaging system, in contrast, avoids such issues by keeping the communications on a secure server and using a standard 128 bit (or greater) encryption method such that when the authenticated user retrieves his or her messages (including embedded patient identifiable information) from the server, no public access is permitted. Thus, straightforward and secure communication implementations are provided that are fully HIPAA compliant.

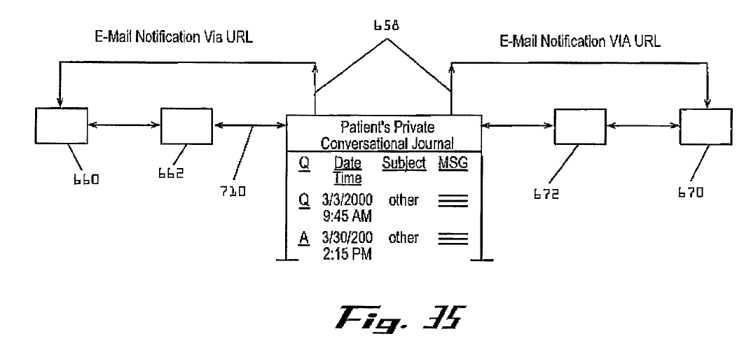

The notification of a message about a particular patient may sent via standard e-mail, but the actual interaction or substantive communications, is done on the patient's private bulletin board. Thus, the bulletin board journals all interactions for future reference. FIG. 35 is a representative schematic of this process. As shown, the patient's private bulletin board 650, which shows the type 651 of message (question or answer), the date and time 652 of the message, the subject 653 of the message, and the actual message 655. As represented by the arrow 658, a standard internet based e-mail notification is sent via a pager. PDA, computer or other suitable device, indicated generally at 660, to the doctor or clinician 662. The clinician 662 then uses the intelligent router 610 to interface with the private patient bulletin board 650. Similarly, a conventional internet based e-mail notice is sent out to a patient as indicated by line 668. As with the doctor or clinician, that notification is received by means of a pager, PDA, computer or other suitable device indicated at 670. The patient 672 retrieves that notice and interacts with the private patient bulletin board via the intelligent router 610.

Another preferred feature of the present invention are disease state monitor alerts. These alerts are messages that are generated as a result of rules built into the monitoring events feature of the patient's therapy plan. These messages are sent when the system detects that information about a patients' health indicators exceed or defeat an algorithm associated with a particular health indicator. For example, the pre-selected maximum heart rate for a particular patient might be set by the clinician at 90 beats per minute. The patient may have recently checked his or her heart rate and determined that it exceeded this pre-set parameter. The patient would then use the monitoring system to input that information into the patient's therapy plan. The monitoring feature of the event monitor 600 would compare the patient's input rate to that of the pre-set 90 beats per ;minute parameter. The event monitor, once it determined that the pre-set rate had been exceeded, would issue a disease state monitor alert to the appropriate doctor or clinician. At that time, a message would be sent to the clinician (or an agent thereof) as described above.

Another preferred feature of the present invention is cascade messaging 243, which is the process of sending notifications to additional recipients in the event the originally-intended previous recipient could not respond within a pre-set amount of time. The amount of time is to be defined by either the clinician or a system administrator. The number of additional recipients (AR) may also be set by a clinician or system administrator. Moreover, the patient may also determine these additional recipients. for example, assume that patient 1 receives professional health care from clinicians A, B, C, D and E. Further, presume that the predetermined set or amount of set time is fixed at 30 minutes. Patient 1 sends a notification message to clinician A. However, due to other commitments, clinician A does not respond within the pre-selected 30 minute period. Upon the expiration of this time period, clinician B is notified. Similarly, if clinician B does not respond within the pre-set 30 minute period, clinician C is notified and so on. Cascade messaging may be used for disease management alerts, communications with the patient, communications between physicians and a clinician, and other notifications where a clinician or physician deem it appropriate. Each of these functions may be applied to the various types of messages or communications provided by the system. Thus, the matrix according to the following template may be followed:

The message manager 620 serves to manage the process of dispatching messages to any of the servers, including the STMP, SNPP, or TAP servers, which send messages to cellular phones, pagers, PDA's, computers, fax services, e-mail, etc. Thus, the functions of the message manager 220 include: (a) prioritizing the messages to be dispatched; (b) concatenating multiple messages into single message strings; (c) identifying single or multiple recipient addresses; (d) communicating with the servers; and (e) providing guaranteed messaging by flagging successful messaging events and reinstating unsuccessful messaging events (including prioritization for re-sending of those messages).

While the invention has been described in detail with particular reference to a preferred embodiment thereof, it will be understood that modifications and variations may be made without departing from the scope of the invention as defined in the appended claims. To the extent desired, the applicants incorporate herein by reference the description provided in the provisional application filed previously.

What is claimed is:

1. A method of interactive health care, comprising the steps of:
developing a health regimen for a patient depending on health conditions of said patient;
loading said health regime into a personal web page suitable for access by said patient and at least one clinician;
scheduling health regimen communications between said patient and said clinician, said communications scheduling including a monitoring and reminder system utilizing a network of computers and at least one personal communications device; and
dispatching communications from one of said patient or said clinician to the other upon occurrence of a regimen event by means of said computer network and said personal communications device, whereby said clinician is made aware of said event and can, by means of said network of computers and personal communications device, monitor and amend said health regimen as necessary.

2. The method of claim 1 further comprising the step of conducting courses regarding medications and disease state regimen for said patient, testing said patient's knowledge and execution of a health regimen resulting from said courses, and certifying said patient's knowledge and execution of said health regimen.

3. The method of claim 2 further comprising the step of providing individualized personal health newsletters to the patient by means of said computer network and personal communications device.

4. The method of claim 3 wherein said monitoring and reminder system includes an interactive calendar that identifies monitoring events and medication events.

5. The method of claim 3 further comprising the step of on-demand electronic interaction between said patient and said clinician.

6. The method of claim 3 wherein said monitoring and reminder system includes escalation alerts whereby, should said patient performance of a monitoring event exceed a clinician's predetermined condition, an alert is automatically provided to said clinician.

7. A method for providing interactive health care services comprising the steps of:
obtaining a patient profile;
loading said patient profile into a web page for the planning and scheduling of medical care;
providing access to said web page by at least said patient for the purpose of monitoring said patient's progress relative to said plan or schedule; and
tracking said patient's progress so as to improve the care provided thereby.

8. The method of claim 7 further comprising the step of providing access to said web page by a clinician whereby said clinician may monitor said patient's progress and influence said plan and schedule of medical care.

9. A system for providing interactive health care services, comprising:
an electronic personalized data sheet reflecting the medical history of a patient to be treated;
means for accessing said electronic personal data sheet by both said patient to be treated and a health care provider so as to establish a plan for the treatment of said patient,
means for recording the progress of said treatment by said patient;
means for remotely observing said recorded progress by at least said health care provider,
whereby said health care provider can monitor and certify the progress of said patient in relation to said health care plan.

10. The system of claim 9 further including an alert device for informing said patient to be treated when said patient deviates from said plan.

11. A system for providing interactive health care services, comprising,
a patient's module, said patient's module comprising a web page including links to health related areas of interests, further including a health regimen to be performed by a patient;
a provider's module, said provider's module comprising a database including information pertaining to one or more patients served by a clinician and their respective health regimens; and
a communications module, said communications module facilitating communication between patients and said clinician, said communications module providing for private and secure communication such that, upon occurrence of a health related event, said clinician may monitor, track and amend the health regimen of any of said patients.
